(19) United States
(12) Patent Application Publication
(10) Pub. No.: US 2014/0106100 A1
(43) Pub. Date: Apr. 17, 2014

(54) Container, in Paticular a Self-Supporting Container, and a Method for Producing the Same

(71) Applicant: Georg Weirather, Osterberg (DE)

(72) Inventor: Georg Weirather, Osterberg (DE)

(21) Appl. No.: 14/132,467

(22) Filed: Dec. 18, 2013

Related U.S. Application Data
(63) Continuation-in-part of application No. PCT/EP2012/002623, filed on Jun. 21, 2012.

(51) Int. Cl. B29C 70/08; B29D 22/00

(52) U.S. Cl. CPC B29C 70/08; B29D 22/003
USPC 428/36.1; 264/102

(57) ABSTRACT

The present general inventive concept relates to a container, preferably a tank, in particular for liquids, wherein the container comprises at least one fiber-reinforced plastic component, wherein the fiber-reinforced plastic component comprises a combination mat, in particular a sandwich mat having a nonwoven structure and reinforcement materials that are connected to the nonwoven structure, in particular fiber materials.

### CROSS-REFERENCE TO RELATED APPLICATIONS

This application is a continuation-in-part of PCT/EP2012/002623 filed on Jun. 21, 2012, which claims the benefit of DE 10 2011 105 300.3, filed Jun. 22, 2011.

### STATEMENT REGARDING FEDERALLY SPONSORED RESEARCH OR DEVELOPMENT

Not Applicable.

### BACKGROUND OF THE INVENTION

1. Field of Invention

The invention relates to a container, preferably a tank, in particular for liquids, wherein the container comprises at least one fiber-reinforced plastic component, as well as a method for producing the same.

2. Description of the Related Art

The production of containers that were preferably used as tanks for liquids, for example organic liquids such as organic waste, was done by means of manual laminating methods. For this purpose, to start with, a layer of a semi-finished fiberglass from a shortcut-fiber mat and a fiber composite or a web was placed in a mold. Then the semi-finished fiberglass was impregnated with, for example, an unsaturated polyester resin and air inclusions were rolled out using a roller.

After a first layer was made in this way, another layer of the semi-finished fiberglass is applied to the hardened first layer, and these steps are repeated until the desired materiel thickness is achieved.

As a rule, the containers according to the state of the art are constructed from two parts, comprising in particular an upper shell and a lower shell, which are joined by means of a lamination process. To begin with, the upper and lower shells are produced using the manual lamination process described above. In the state of the art, in order to provide the container with the required stability, in a more advanced embodiment, reinforcement walls, so-called slosh walls, are incorporated into the container. The slosh walls are also produced using the manual lamination method. To this end, with a first method according to the state of the art, a supporting mold for the laminate was placed in the tank, and a rear wall and the reinforcement walls, preferably the slosh walls, were laminated onto the tank wall of the lower shell. Alternatively the reinforcement walls, i.e. the slosh walls could be prefabricated, protruding glass fibers cut off and the reinforcement wall then laminated onto the lower shell using adhesive resin. In the state of the art, any adhesive resin applied served the purpose of fixation only, making

It possible to laminate on the slosh wall, or as the case may be reinforcement wall after fixation.

As a rule, not just one fiberglass mat is used in producing a container, but rather a plurality of fiberglass layers: for example up to 5 or more fiberglass layers, or as the case may be fiberglass mats, are arranged one above the other in order to produce the container. As described above, in the state of the art, each single layer must be made in a plurality of individual steps, i.e. by application of the woven mat, saturation of the same with resin, expulsion of the air inclusions by means of rolling them out, hardening. This was a very complex method.

The lamination process according to the state of the art, for example, employing manual lamination, takes place as follows. First, in a negative mold, a gelcoat that is resistant to UV radiation and abrasion, and which can be colorless or colored, is applied and allowed to dry. Colorless or colored resin is then applied to the dried gelcoat, and then the shortcut fiber mat is applied and coated with resin as well. Due to the internal binder in the shortcut-fiber mat, which dissolves in the styrene in the resin, it is necessary to wait for a short time until the shortcut-fiber mat can be rolled onto, or as the case may be adapted to the contour of the negative mold using a roller, for example. Once the shortcut-fiber mat has been adapted to the contour using the roller, the fiberglass fabric can be inserted and coated with resin. When a plurality of fiberglass fabric layers are arranged one on top of the other, and when the underlying layers harden, the hardened layers must be coated once again with resin so that additional fabric can be applied, for example the second or the third fabric layer, and these layers then coated with resin. The described laminate construction is repeated, layer by layer, until the complete construction, for example one having five fiberglass layers, has been produced. The previously described reinforcement walls, which are also called slosh walls, are also produced using a lamination method as described above, wherein a shortcut-fiber mat can be laminated over the seams on the inner surface that are produced during subsequent insertion of the reinforcement walls in the already produced lower shell.

The disadvantage of the method according to the state of the art was, on the one hand, the environmental pollution resulting from the volatile substances that escape into the environment as the adhesive resin hardens, as well as the complex production, for example, of reinforcement regions by means of subsequent lamination of reinforcement layers. And longitudinal reinforcement in the coatings and reinforcement in the region of flanges had to be accomplished in an additional work process.

The containers that were produced according to the state of the art using the method described above had the disadvantage that they distinguished themselves only by having very low fiber-volume content. For example, the fiber-volume content was at most 35%. An additional problem was that the surfaces according to the state of the art were not sufficiently smooth. The inside surface of the container therefore exhibited a slight mat structure. An additional disadvantage was that the containers according to the state of the art also had a high porosity of more than 10%.

This resulted in containers according to the state of the art not having sufficient strength to be self-supporting containers. Containers according to the state of the art still always had to be braced up by means of supporting devices which support the container.

Another disadvantage of the container according to the state of the art was that no large container volumes of more than 10,000 L, in particular more than 16,000, preferably within the range of 16,000 L to 30,000 L, were possible with simple production with high quality in the container surfaces.

From U.S. Pat. No. 3,010,602, a fiberglass tank is known, wherein by means of pressure and peeling-off of excessive resin, a fiber-volume ratio of >60% is attained; however in U.S. Pat. No. 3,010,602, no statement is made concerning porosity, nor is the production method described. The sizes of the tank are not given.

U.S. Pat. No. 2,977,269 describes a method of producing a tank from fiberglass that has a high density of interlocking reinforcement fibers. A fiber-volume ratio is not given for U.S. Pat. No. 2,977,269; nor is a detailed production process described.

DE 101 40 166 describes a method and a device for making fiber-reinforced plastic components from dry fiber-composite semi-finished materials by means of an injection method and subsequent hardening. However DE 101 40 166 does not describe the production of tank containers, and furthermore the fiber-volume ratio and porosity of the components are not specified.

EP 1 393 883 describes a method, a device, and a tool arrangement for producing components from fiber-composite products by means of temperature and pressure-controlled injection technique. EP 1 393 883 also does not present the production of tank containers, nor does it specify the fiber-volume ratio or the porosity of the components.

### BRIEF SUMMARY OF THE INVENTION

The object of the invention is to avoid the disadvantages of the state of the art that are described above and in particular, in a first aspect of the invention, to provide a container which, compared to the state of the art, features improved material properties, in particular better quality. In particular, the intention is also intended to provide large-volume containers with a high-quality surface.

In addition, according to a second aspect of the invention, a method is presented which provides, in an environmentally-sound way, containers with the inventive properties.

Inventively, this object is achieved by means of a container, in particular one in the form of a self-supporting container, preferably a tank, in particular for liquids, whereby the container is comprised of at least one fiber-reinforceable plastic component. The plastic component, which at least partially forms the container, is characterized in that the fiber-reinforced plastic component comprises a combination mat, in particular a sandwich mat having a nonwoven structure, and reinforcement materials that are connected to the nonwoven structure, preferably shortcut fibers.

In this way, in contrast to the use of pure shortcut-fiber mats, washing-out is prevented when resin is fed in.

In some example embodiments of the present general inventive concept, a container, preferably a tank, in particular for liquids, includes at least one fiber-reinforced plastic component, wherein the fiber-reinforced component includes a combination mat, in particular a sandwich mat having a non-woven structure and reinforcement materials that are connected to the nonwoven structure, in particular the fiber materials.

In some embodiments, the nonwoven structure is a polypropylene (PP) structure.

In some embodiments the fiber material is comprised of carbon fibers (CFK), aramide fibers (AFK) or boron fibers (BFK), or hybrid materials.

In some embodiments, the plastic component has a fiber-volume ratio greater than 40%, in particular in the range 40-80%, preferably in the range 40-50%.

In some embodiments, the plastic component has a porosity less than 10% in particular <5%, very preferably <1%, particularly preferably in the range of 1%-0.1%, and/or a surface that has a very high degree of smoothness.

In some embodiments, the container has a volume and the volume is greater than 10,000 L, preferably greater than 16,000 L, in particular greater than 20,000 L, and preferably in the range 10,000 L to 40,000 L, in particular 16,000 L to 30,000 L.

In some embodiments, the container is designed as having at least two parts, whereby the first container part is an upper shell, and the second container part is a lower shell.

In some embodiments, at least one shell has joining surfaces and on the joining surfaces an adhesive is applied, in particular a vinyl ester adhesive, in order to join the shell.

In some embodiments, in order to insert the reinforcement walls, an adhesive, in particular a vinyl ester adhesive, is applied to the lateral walls of the container.

In some embodiments, the container includes reinforcement walls.

Some example embodiments of the present general inventive concept include a method of producing a container, preferably a tank, in particular for liquids, wherein the container is produced from a dry fiber-composite semi-finished material by means of an injection method for injecting matrix material, comprising the following steps: arranging of dry fabric layers in the form of combination mats in a mold producing a dry fiber-composite semi-finished material; forming a first space by means of a membrane that is permeable to gas and impermeable to matrix material, wherein the first space surrounds the dry fiber-composite semi-finished material; forming a gap between the first space and the second space lying in the surrounding area by means of a foil that is permeable to gas and matrix material; and injecting matrix material into the first space and the extraction of air from the second space, whereby the matrix material permeates the dry fiber-composite semi-finished material, produces at least one part of the container, in particular of the self-supporting container, preferably of the tank.

In some embodiments, combination mats are comprised of carbon fibers (CFK), aramide fibers (AFK), boron fibers (BFK), or hybrid materials.

Some example embodiments of the present general inventive concept include a method of producing a container, preferably a tank, in particular for liquids, whereby the container is made from a dry fiber-composite semi-finished material by means of an injection method for injecting matrix material, comprising the following steps: arranging of dry fabric layers in the form of combination mats producing at least one part of the container in a female mold producing a dry fiber-composite semi-finished material; arranging of a male mold in relation to a female mold in such manner that the fiber-composite semi-finished material comes to rest between the female mold and the male mold; injecting matrix material into the space, supported by a pressure or height differential between the female mold and the male mold, in particular by means of a pump, in such a way that the matrix material permeates the dry fiber-composite semi-finished material, producing at least one part of the container, in particular the self-supporting container, preferably the tank.

In some embodiments, before injection of the matrix material, the male mold and female mold are brought into contact with each other by means of a locking vacuum.

In some embodiments, before and during injection of the matrix material, a container volume is formed.

In some embodiments, the injection of the matrix material is done under an injection pressure of 0.5 to 0.7 bar, preferably provided by a pump.

In some embodiments, the dry fabric layers produce the form of a lower shell of the container.

In some embodiments, the dry fabric layer in the form of a lower shell (3), in the reinforcement region of the lower shell, includes additional fabric layers of continuous-strand mats.

In some embodiments, the container, in the region of the reinforcement walls, has additional fabric layers.

Some embodiments include the use of a method as described above for producing containers, in particular self-supporting containers, preferably a tank, in particular for liquids.

Some embodiments include the use of a method as described above wherein the container has a volume and the volume is greater than 10,000 L, preferably greater than 16,000 L, in particular greater than 20,000 L, and preferably in the range 10,000 L to 40,000 L, in particular 16,000 L to 30,000 L.

### BRIEF DESCRIPTION OF THE SEVERAL VIEWS OF THE DRAWINGS

The above-mentioned features of the present general inventive concept, as well as other features, will become more clearly understood from the following detailed description of the present general inventive concept read together with the drawings, but without limitation thereto. The following is shown:

FIG. 1a-1b a container with an upper shell and a lower shell, as can be produced according to the invention, in a sectional view and a lateral view of the upper shell.

FIG. 2 a principle view of the production of a lower shell according to the first inventive method (VPN method).

FIG. 3 a principle view of the production of a lower shell according to the second inventive method (RTM method)

FIG. 4 a principle view of a combi-mat and its construction.

FIG. 5a, 5b Installation of the slosh walls according to the state of the art and according to the invention

FIG. 6a, 6b Joining the upper and lower shells according to the state of the art and according to the invention

### DETAILED DESCRIPTION OF THE INVENTION

In a preferred embodiment, the nonwoven structure comprises a polypropylene (PP) structure. Particularly preferably, the fiber material consists of carbon fiber (CFK), fiberglass (GFK), aramide fiber (AFK), boron fiber (BFK), or hybrid materials.

In one advantageous embodiment, the fiber-volume ratio is greater than 40%, in particular in the range 45-80%, preferably in the range 40%-70%, very particularly preferred 40% to 50%, lying in particular also in the range 60% to 70%, and/or the porosity of the plastic component is smaller than 10%, in particular smaller than 5%, very particularly preferred <1%, particularly preferred as lying in the range 1%-0.1%.

The inventive containers are characterized by a much higher laminate quality than the state of the art and due to the high fiber-volume content, by sufficient strength, for example for a self-supporting tank. The low porosity has the advantage that the product displays a better quality. In particular, the product is distinguished by having a surface with a very high degree of smoothness with a low average roughness RZ, which can even be felt very distinctly with the fingers.

The average surface roughness is determined by means of an electric profilometer according to DIN 4768, sheet 1, edition 1974. In the current notification, roughness is understood as the regularly and irregularly recurring deviation in shape in the surface of solid bodies according to the VDI lexicon Werkstofftechnik [“Materials Engineering”], published by Hubert Gräfen, VDI-Verlag 1993, whereby the ratio of the deviation in shape to its depth lies between 100:1 and 5:1. The difference in surface roughness is readily obvious to the naked eye.

In particular, the inventive containers are characterized by smooth inner surfaces that display no mat structure at all.

As shown, the inventive containers are characterized by a much higher laminate quality than the state of the art, and due to the high fiber-volume content, sufficient strength, for example for a self-supporting tank. The low porosity has the advantage that the product displays a better quality. Furthermore, the products, both on the inside and the outside, display a very high level of smoothness, i.e. a low level of surface roughness. This has the advantage that mat structures in the surface on the inside of the container can be avoided.

A combi-mat according to the invention is, for example, the combi-mat, or as the case may be combination mat Coroplex® from P-D Glasseiden GmbH Oschatz, Wellerswalder Weg 17, D-04758 Oschatz. The combi-mat Coroplex® is a sandwich construction in which one, two, or more E or ECR-glass reinforcement materials (for example shortcut-fiber mats, roving fabrics, multi-axial fabrics, nonwoven fabrics) are mechanically bonded with a PP-nonwoven fabric or a PP-knit fabric. Here, a virtually unlimited number of combinations are possible.

The invention particularly preferably provides containers with a volume greater than 10,000 L, preferably greater than 16,000 L, in particular greater than 20,000 L, and preferably in the range 10,000 L to 40,000 L, particularly 16,000 L to 30,000 L.

In a particularly preferred embodiment, the container is designed as having at least two parts, in particular a first container part comprised of an upper shell 77 and a second container part comprised of a lower shell 3, which are produced separately and joined after production. Preferably, when the container is formed as a self-supporting container, the second container part, i.e. the lower shell, is provided with reinforcement regions, for example, in that in the region of the bottom of the lower shell, the thickness of the laminate layers is greater than, for example, that of the walls.

In addition to the reinforcement regions, the inventive container may include so-called slosh walls, which strengthen the container in the transverse and longitudinal direction.

It is particularly environmentally sound when, as a method of producing an inventive container, a so-called injection method is used, as shown for example in a first embodiment in DE 100 13 409 C1, whose disclosure is fully included in the current notification.

With the inventive method of the first embodiment (VAP method), in order to produce the container, a dry pre-form, or as the case may be a dry fiber-composite semi-finished material is made, into which dry fabric layers, including, in particular, carbon fiber (CFK), fiberglass (GFK), aramide fiber (AFK), boron fiber (BFK) or hybrid materials are placed in a negative mold. To this, to begin with, an UV-radiation and abrasion-resistant gelcoat is applied to the inside of a negative mold and allowed to dry inside the negative mold. According to the invention, combi-mats are placed in the mold and can be fixated with a spray adhesive. Alternatively, single fiberglass fabrics can also be placed in the negative mold and fixated with spray adhesive. The dry construction in the negative mold also makes it possible to insert, for the purpose of potential reinforcement, in addition to the fabric layers consisting for example of combi-mats or fiberglass continuous-strand mats or fiberglass fabric, of other semi-finished materials, for example mats made of other materials such as aramide fibers (AFK) or boron fibers (BFK). In addition, a tear-off fabric can be applied to the counter-mold. After the entire layer build-up, and possibly the addition of tear-off fabric, have been completed during the first step, in an additional procedural step, a membrane is applied over the fiber-composite semi-finished material, thereby forming a first space that encloses the dry fiber-composite, semi-finished material. The membrane is permeable to gas, but impermeable to the liquid matrix material that is to be applied, which hardens encloses the dry fiber-composite, semi-finished material. In order to seal off the first space formed by the membrane, the membrane can be glued to the edge of the mold of the negative mold, for example with a sealing tape.

In a further procedural step, with the first method (VAP method), a second space is formed between the first space and the environment by means of foil that is impermeable to gas and matrix material. In this way, the environment is completely protected from gases that escape during the manufacturing process. The second space can, for example, be formed by a vacuum bag which is arranged above the first space, wherein the vacuum bag is attached with sealing tape to the edge of the mold of the negative mold, so that the membrane, which is permeable for gas and impermeable for the matrix material, also lies under the vacuum bag.

After the formation of the first and the second spaces, the matrix material, in particular duroplastic resins such as unsaturated polyester resin, vinyl ester resin, or epoxy resin are injected into the first space. After introduction, or as the case may be injection of the matrix material into the first space, air is simultaneously suctioned out of the second space, the second space extracting the gases that form during the drying of the matrix material in the first space. The injected matrix material penetrates the dry fiber-composite semi-finished material in the first space, by which means, after hardening, one part of the container is formed. In this way in particular, a self-supporting container can be produced. In particular, the injection of the resin functions such that the air is evacuated from the previously described first space, i.e. the mold, until a vacuum forms under the vacuum bag. The resin, or as the case may be the matrix material is drawn by the surrounding vacuum into the layer, and the membrane, which is impermeable to the resin, prevents the resin from penetrating into the pump circuit. All of the fiber-composite semi-finished material, which is surrounded by the membrane, then fills up with resin, and after hardening, the component, with a fiber-volume ratio of >40%, particularly in the range 45-80%, preferably in the range 50-70%, in particular in the range 60-70% and/or a porosity of <10%, preferably <5%, very preferably <1%, in particular in the range 1% to 0.1%, can be removed from the negative mold. The hardening, as a rule, takes place at room temperature, whereby an escape of vapors into the environment is prevented by the foil that cuts the second space off from the environment. If hardening does not take place at room temperature, as for example in the case of unsaturated resin, a supportive hardening can be undertaken using a mold-heating means. Resins that require this kind of mold-heating are, for example, vinyl ester resin and epoxy resin.

Instead of the previously described method according to DE 100 13 409 C1, which is also termed the VAP method, it is also possible to use a plastic mold and a plastic counter-mold as a method of producing the inventive container. In the current notification, the plastic mold is also called the female mold and the plastic counter-mold the male mold. The plastic form, or as the case may be the female mold, can be equated with the negative mold according to the first method.

The second possible method is also called the Light RTM (Light Resin Transfer Molding). The advantage of this method, particularly in comparison to the VAP method, is less complexity in production, which is reflected particularly in lower production costs.

With the RTM method, as in the case of the previously described VAP method, a matrix material, preferably a duroplastic resin, is also introduced, i.e. injected, into an intermediate space. In contrast to the previously described method, the injection of the matrix material, in the case of the light RTM method, is supported by a pump or a difference in height. Furthermore, in addition to the negative mold, or as the case may be the female mold, as with the VAP method, an additional opposing mold, preferably a plastic counter-mold, or as the case may be a male mold, is used. Using the pump, or as the case may be the height difference to suck in the matrix material when using the light RTM method, causes the matrix material, in particular the duroplastic resin, to be squeezed under light pressure between the negative mold and the opposing mold, preferably the plastic opposing mold. In this way, a very smooth surface is achieved, both on the inside and the outside of the component produced in this manner.

Hereinafter there will be once again a brief description of the process involved in the light RTM method.

As previously described, for the RTM (Resin Transfer Molding) method, a plastic mold (male mold) and a plastic opposing mold (female mold) are used. In contrast to the laminating method with a press mold, in the case of the light RTM method used, the edge of the female mold is wide enough to accommodate a resin channel, a sealing gasket, a locking vacuum and an end seal.

Between the female and male molds, which are designed as fixed molds, a predefined gap is formed, which is produced by means of a displacement laminate. With the light RTM method, resin is injected on one side, for example from above, from below, or transversely, for example using a pump or gravity, and suctioned off at the opposite side until resin reaches the vacuum circuit.

Particularly preferably, prior to the injection of the matrix material, male mold and female mold are brought into contact by means of a locking vacuum, or are, as the case may be, closed. Furthermore, a container vacuum is formed before and during the injection of the matrix material.

It is particularly advantageous if the injecting, or as the case may be the injection of the matrix material takes place under an injection pressure of 0.5 to 0.7 bar, which is preferably provided by a pump.

In detail, in order to produce a container, or as the case may be a container part according to the RTM method, in one possible embodiment, a gelcoat is first introduced into the mold, then the gelcoat is dried, and fiberglass is applied to the gelcoat. After that, all fiberglass layers are fixated by means of an adhesive. During the production of the fiberglass layers, all reinforcements are put in at the same time. As with the previously described method, it is possible to place the fiberglass material into the mold as combination mats, for example in the form of continuous strand mats that are folded to produce a multilayer construction, or as single mats. After the insertion of all fiberglass, including the reinforcements, the plastic opposing mold for introducing the resin and possibly the hardening agent is prepared.

One possible combination mat is Coroplex® from P-D Glasseiden GmbH Oschatz, as described above.

The preparation is comprised of the connection, for example of the vacuum exhaust lines and the locking vacuum to the vacuum pump. By means of the vacuum pump, the locking vacuum channel and the component are evacuated. Then, using a pump, a hardening agent is mixed with the resin, and the resin containing the hardener is conveyed via a main line connected to a sprue nozzle into the resin channel, preferably under a pressure of 0.5 to 0.7 bar. The resin disperses from the resin channel into the gap between the male and female molds, into which the fiberglass, or as the case may be the fiberglass mats have been placed.

The amount of resin required to manufacture a container is pumped into the gap.

The use of combi-mats instead of pure shortcut-fiber mats prevents the fiber material from being washed out of the position into which it has been placed during injection of the resin under pressure. In the case of the combination mats, the anchoring of the fiber material in the nonwoven structures prevents the fiber materials from being washed out, or as the case may be washed away. The combi-mat is thus a kind of flow-aid for the resin that is directed into the gap. The nonwoven structure of the combi-mats is, in particular under the pressures of 0.5 to 0.7 bar used during the injection of the resin material, largely incompressible.

With the injection of the resin, all of the inserted fiberglass layers, all reinforcements, including the longitudinal reinforcements, are successively saturated. But the fiberglass layers harden virtually simultaneously. In this way, very good strength with very few air inclusions is attained. Furthermore, the component produced in this way is under very low tension.

With the previously described method (RTM), with the same wall strength as a manually laminated component, more glass fibers can be inserted and injected, preferably up to 60%, very preferably up to 50%, in particular up to 40% more fiber-volume ratio. The resin that is put into the gap flows in the gap, and in that way in the component for a vacuum-exhaust support which is formed in the gap.

Once the component is fully formed, the gelcoat bonds with the resin and detaches itself from the mold during de-molding. After the component has hardened, the plastic opposing mold (male mold) is separated from the component by means of compressed air, and the component is removed.

It is especially advantageous, during production of the component, for example the production of the lower shell or the upper shell, or as the case may be the reinforcement walls, the so-called slosh walls, that in contrast to the currently used production process, all of the reinforcement layers in the reinforcement regions are applied immediately to the dry fiber-composite semi-finished material, so that subsequent lamination into or onto the material, as is the case in the state of the art, is no longer required. Furthermore, the inventive method makes it possible complete the layer construction before introducing the matrix material, i.e. before sealing it with resin.

Thus, instead of stringing together short webs that are, for example, 1.5 meters in length, continuous webs that are 5-7 m in length can be used. Furthermore, the formation of overlaps is then no longer necessary.

Also in the case of the reinforcement walls, for example the slosh walls, it is possible to produce the reinforcement walls in one piece, with all mating flange-surfaces, so that it is only necessary to glue the reinforcement walls into the lower shell 3, for example using a vinyl ester adhesive. Laminating them in, as in the case of slosh walls in the lower shell 3 in the state of the art, is no longer necessary.

The inventive method is particularly useful in the production of containers, preferably tanks, in particular with a volume greater than 10,000 L, preferably greater than 16,000 L, in particular greater than 20,000 L, and preferably in the range 10,000 L to 40,000 L, in particular 16,000 L to 30,000 L. Furthermore, the method is employed in particular for the production of agricultural containers. The method can also be used for the production of self-supporting containers or wind-turbine blades.

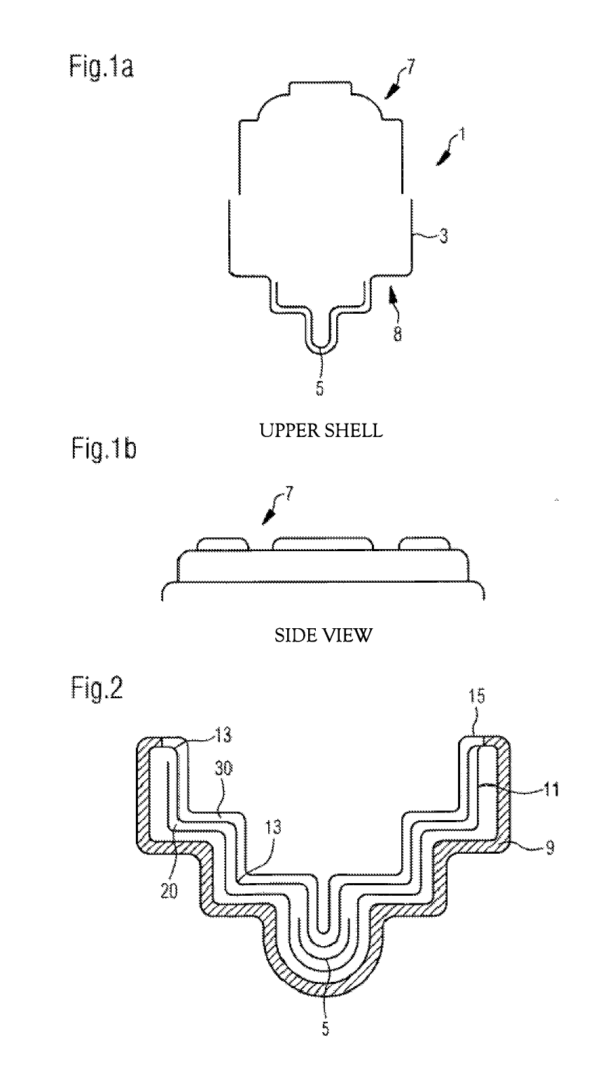

Turning to the illustrated example embodiments shown in the Figures, FIG. 1a shows, in a front view, the basis design of a two-part container according to the invention. The two-part container 1 is comprised of an upper shell 7 and a lower shell 3, which, tightly connected to each other, form the inventive container. A lateral view in FIG. 1b shows only the upper shell 7. Reinforcement layers 5 have been placed in longitudinal direction in the lower shell 3 for a self-supporting construction (not shown).

Furthermore, slots 8 can be easily discerned, which, should the depicted container be used as a wheeled vehicle, can accommodate the wheels.

The low porosity, as a rule less than 10%, in particular lower than 5%, preferably lower than 1%, of the inventive plastic components, here in the form of a lower shell 3, has the advantage that a higher mechanical strength can be attained. In combination with the higher fiber-volume content that is greater than 40%, preferably greater than 50%, particularly 40%-80%, preferably 40% to 50%, preferably 0-70%, in particular 60-70%, of the inventive component, the higher mechanical strength is attained with obviously reduced weight compared to the state of the art, as well as a very smooth surface with low surface roughness RZ.

FIG. 2 now illustrates only the apparatus for producing the lower shell 3, with all devices required for implementing the inventive method according to the first embodiment (VAP method). Shown in a clearly visible manner is the negative mold 9, into which, in order to produce the container component, combination mats, abbreviated combi-mats, or as the case may be continuous-strand mats 11, but also shortcut-fiber mats, which folded one over the other produce a multi-layer region (not shown) in the container. Preferably, according to the first embodiment of the inventive method, as shown in FIG. 2, single mats are not used, but rather continuous-strand mats 11, in particular combination mats. Above the mats placed in the negative mold, said mats being duplicated 5 in the reinforcement region, a membrane 13 impermeable to the matrix material is placed. The membrane 13, although impermeable to the matrix material, is permeable to gaseous media, such as for example air and evaporations that occur during the hardening. A membrane of this kind is described in DE 100 13 409 C1. The disclosure in this document is taken fully into account in the current notification.

Above the membrane, which is impermeable to the matrix material but permeable to the volatile substances, a foil 15 is arranged, which is impermeable to both the matrix material and the volatile media. Between the membrane 13 and the mold is a first space 20; between the foil 15 and the membrane 13, a second space 30. The second space 30 is also designated a vacuum space or vacuum bag. With the inventive VAP production method, the continuous-strand mat 3, or as the case may be the single webs, are placed in the mold 9, possibly along with the required reinforcements, i.e. the duplications 5 in the reinforcement region, tear-off fabrics, resin-flow channels, and resin sprues. After the mats have been inserted dry into the mold, the membrane 13 is arranged, as well as the foil 15 above the membrane, resulting in the first and second space 30. Then the first space 20 is evacuated, and after evacuation of the first and second space 30, matrix material in liquid form is fed into the first space 20. The matrix material encloses the dry semi-finished material 13 in the form of nonwoven mats and hardens, either at ambient temperature or a produced temperature, whereby the gases that escape during this process are extracted through the membrane 13 into the second space 30 and then via the vacuum out of the second space 30 without entering the environment.

In order to seal off the first space 20 and second space 30 from the environment, both the membrane 13 and the foil 15 that forms the vacuum bag fit against the mold 9 and are affixed to the mold 9 with sealing tape. After hardening of the matrix material, the membrane 13 and the foil 15 can be removed, and the finished component can be removed from the mold 9. The component produced according to the method seen in FIG. 2 has a very high fiber-volume content >40% compared to conventionally produced components, as well as low porosity of less than 10%, preferably less than 5%, particularly less than 1%. The high fiber-volume content of >40% and the low porosity is achieved in particular by means of the high compression in the vacuum, in which a negative pressure of 0.8 bar or more acts on the laminate. With the VAP method, shortcut-fiber mats can also be processed.

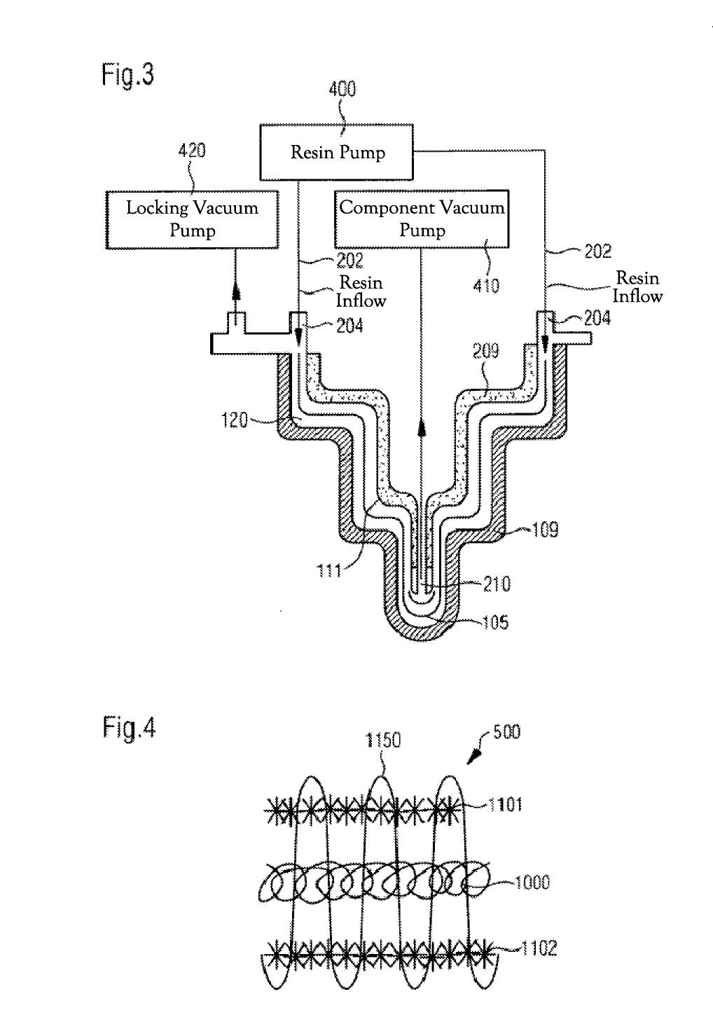

FIG. 3 shows a device for producing a lower shell 3 according to the second embodiment of the inventive method (RTM method). Components identical to those in FIG. 2 are designated by figures raised by 100.

Easily recognizable are fiberglass mats 111 configured as combination mats, which folded one over the other produce a plurality of fabric layers. A combi-mat, or as the case may be a combination mat according to the invention is, for example, the combi-mat Coroplex® from P-D Glasseiden GmbH Oschatz, Wellerswalder Weg 17, D-04758 Oschatz. The combi-mat Coroplex® is a sandwich construction in which the one, two, or a plurality of E or ECR glass reinforcement materials (for example, shortcut-fiber mat, roving fabric, multi-axial fabric, nonwoven fabric) are mechanically combined with a PP-nonwoven or PP-knit fabric. Here a virtually unlimited number of combinations is possible. The schematic construction of a combination mat of this type is shown in detail in FIG. 4. Instead of multiple layers, single mats, for example from combination mats, can of course be used. Also easily discernible is the negative mold, which is also designated as female mold 109. After application of a gelcoat, the fiberglass mats are placed in the female mold 109. The application of the gelcoat facilitates de-molding from the female mold 109. Then all fiber layers are fixated, for example by means of an adhesive, in the negative mold, or as the case may be the female mold 109, and any reinforcements in the form of duplications 105 are put in. Then the male mold 209, which is used instead of the foil 15 for the RTM method, is put in. The male mold 209, in contrast to the membrane, is a solid mold. However, female and male molds are not press molds; rather they are preferably kept apart by means of a distancing laminate, so that between the female mold 109 and the male mold 209, a predefined gap 120 is formed. On the edge of the female mold 109, a main line 202 is formed, through which the resin can be conveyed into the gap 120 by means of a resin pump 400, preferably under a pressure of 0.5 bar to 0.7 bar. Furthermore, the female mold has a sprue nozzle, preferably a vacuum nozzle 204. The resin pump 400 is connected to the sprue nozzle and conveys the resin, preferably under pressure, from the main line 202 into the gap 120. Before the resin is conveyed under pressure by means of the pump 400 into the gap, the male mold and the female mold are brought into contact, or as the case may be closed, by means of a locking vacuum. In addition, before and after the injection of the matrix material, a container vacuum is formed, in which the gap 120 is evacuated via the nozzle 210. Downstream from the nozzle 210 is a resin trap (not shown), in order to prevent the resin from the gap 210 getting into the component vacuum pump. The component vacuum pump 410 and the locking vacuum pump 420 can comprise one pump, but they are preferably configured as separate pumps. The resin pump 400 is always separate from the locking vacuum pump 420, or as the case may be the component vacuum pump 410. Without the locking vacuum, or as the case may be the component vacuum, male and female molds would be pressed together when the resin is fed in, in particular due to the injection pressure for the resin, so that no defined form would be achieved for the component. Immediately after the production of the component vacuum, resin is fed, or as the case may be injected via the main line 200, under pressure, into the gap 210. The resin can be mixed with a hardening agent. The mixing can, for example, take place in the resin pump 500. The resin disperses in the gap between male mold 209 and female mold 109. In this way, all of the inserted fiberglass layers 111, in particular the combination mats and reinforcements, are successively saturated. The resin flows, in the gap 120, to the nozzle 210 until the component is formed in the gap.

Then, as described above in connection with the VAP method, the component is hardened, and then the counter-mold, here for example the male mold 209, is removed by means of compressed air and the component is de-molded from the female mold. The component can be easily removed from the female mold due to the gelcoat. Preferably used as combination mats is the combination mat Coroplex® from P-D Glasseiden GmbH Oschatz, Wellerswalder Weg 17, D-04758 Oschatz. The combi-mat Coroplex® is a sandwich construction in which one, two, or a plurality of E or ECR glass reinforcement materials (shortcut-fiber mat, roving fabric, multi-axial fabric, nonwoven fabric) with a PP-nonwoven a PP-knit fabric are mechanically combined. Here a virtually unlimited number of combinations is possible. In FIG. 4, the principal construction of a combination mat of this kind is shown schematically.

FIG. 4 illustrates the basis design of a combination mat 500. The combination mat essentially comprises, without being restricted thereto, 3 layers: a middle layer 1000, which as a rule is the nonwoven structure, for example a PP-nonwoven. Above and below the nonwoven structure, two additional structures, 1101, 1102, are provided, which are a shortcut-fiber mat with individual interlocked fiber sections, approx. 60 in length. In order to prevent the shortcut fibers from flowing out or washing out when the resin is introduced into the gap, it is provided, in the case of the inventive combination mat, by means of filaments 1150, that the shortcut-fiber mats 1101, 1102 are mechanically connected to the nonwoven fabric 1000, in order to prevent the shortcut fibers of the shortcut-fiber mat 1101, 1102 from being washed out when the resin is introduced.

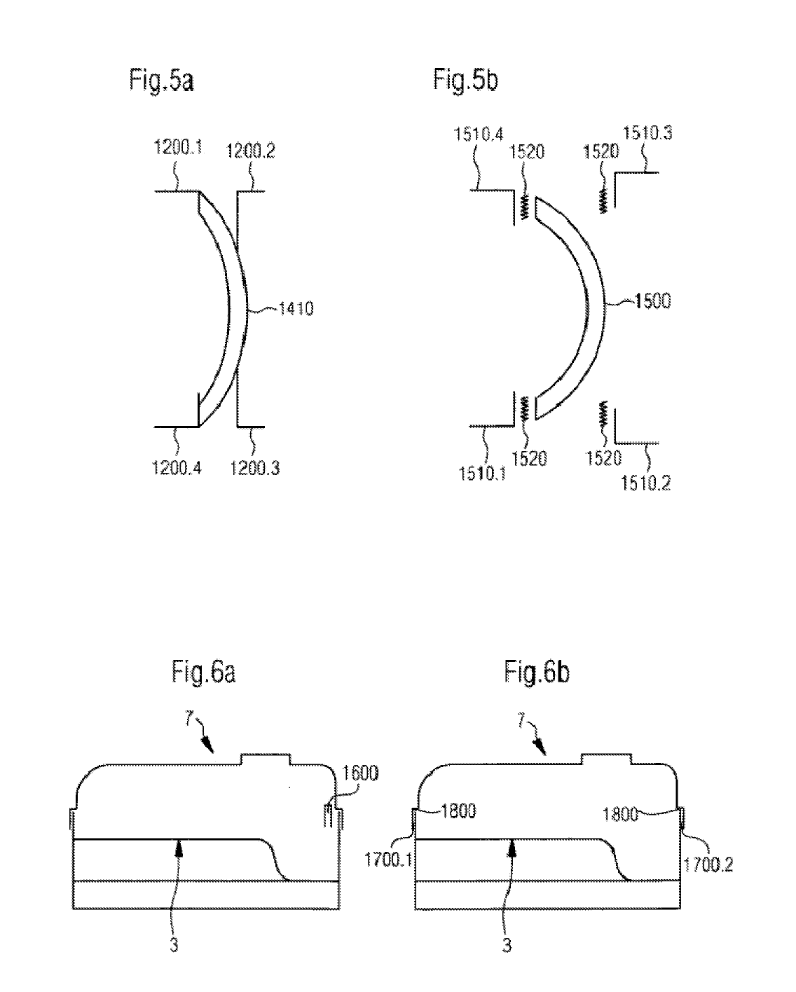

As previously described, not only the actual tank container is produced using the inventive method, but also the individual reinforcement walls, which are termed slosh walls. In the FIGS. 5a and 5b, the method implemented until now, as well as the new inventive method are presented.

With the conventional method, the reinforcement walls are connected to the container walls (not shown) with a laminate 1200.1, 1200.2, 1200.3, 1200.4, and the wall 1410 is attached in that way to the walls of the tank. This is very time-consuming. With the novel production method according to FIG. 5g, the slosh wall 1500 is attached to the tank wall and to the slosh walls 1501.1, 1501.2, 1510.3, 1510.4 through the application of an adhesive and then glued with an adhesive 1520. Because no resin is used here, the emissions can be reduced; in addition, the production time is diminished. Furthermore, the adhesive is more robust than a laminate connection according to FIG. 5a. For bonding in FIG. 5b, a vinyl, in particular a vinyl ester adhesive is preferably used.

Just as the slosh walls are bonded using an adhesive, the upper shell 7 and the lower shell 3 are connected to each other with adhesive exclusively. This is shown in FIGS. 6a and 6b. FIG. 6a shows the connection of the upper disc 7 and the lower disc by means of the method according to the state of the art. The upper shell 7 and the lower shell 3 are circumferentially attached, possibly with additional adhesive, by means of a laminate 1600, preferably consisting of 6 layers of shortcut-fiber mats with a width of 10 cm in upper 7 and lower shell 3.

In contrast hereto, according to FIG. 6b, with the novel method, both the upper shell 7 and the lower shell 3 are individually produced and provided with mating surfaces 1700.1, 1700.2. No additional laminate is laminated onto the two mating surfaces 1700.1, 1700.2; but rather only an adhesive material 1800, preferably a vinyl ester adhesive, is applied.

With the inventive method, the contaminants can be limited to less than 4 ppm, with closed male and female molds during the production process, in the workplace or as the case may be in the exhaust air. The inventive first method (VAP method) and the second method (RTM method) are also particularly advantageous under the aspect of employee protection, because the gases that escape during the hardening process can be selectively discharged, without them entering the environment. This is accompanied by massive emissions and CO2 reductions.

Furthermore, there is no application of reinforcement layers by means of separate lamination, rather reinforcements can already be added during molding, and after addition, matrix material can be fed into them. Due to the finer construction of resin and reinforcement fibers, considerable reductions in weight can be achieved. In addition, it is possible to reduce resin consumption.

The invention applies to aspects that are described in the following propositions, which are part of the description, but which are not claims.

With the present general inventive concept, a simple structure is provided for the first time whereby the process volume to be treated can be extended simply in a modular manner. The process volume can not only be extended by stacking modules. The present general inventive concept furthermore enables a so-called linear scale-up in which the number of feed openings can be extended simply, for example, from 4 to 16 or to 64 feed openings without expensive measurements. This is possible because in the system according to the present general inventive concept, wall effects do not occur when increasing the process volume as in column chromatography. Furthermore the apparatus is characterized by a feed or discharge which for a plurality of feed or discharge openings provides the same line lengths to the respective feed or discharge openings starting from one point.

From the foregoing description, it will be recognized by those skilled in the art that a container, in particular a self-supporting container, and a method for producing the same have been provided.

While the present general inventive concept has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The present general inventive concept in its broader aspects is therefore not limited to the specific details, representative apparatus and methods, and illustrative examples shown and described. Accordingly, departures may be made from such details without departing from the spirit or scope of applicant's general inventive concept.

Still other embodiments will become readily apparent to those skilled in this art from reading the above-recited detailed description in view of all the drawings. It is noted that the simplified diagrams do not illustrate all the various connections and assemblies of the various components, however, those skilled in the art will understand how to implement such connections and assemblies, based on the illustrated components, figures, and descriptions provided herein.

It is also noted that numerous variations, modifications, and additional embodiments are possible, and accordingly, all such variations, modifications, and embodiments are to be regarded as being within the spirit and scope of the present general inventive concept. For example, regardless of the content of any portion of this application, unless clearly specified to the contrary, there is no requirement for the inclusion in any claim herein or of any application claiming priority hereto of any particular described or illustrated activity or element, any particular sequence of such activities, or any particular interrelationship of such elements. Moreover, any activity can be repeated, any activity can be performed by multiple entities, and/or any element can be duplicated. Accordingly, while the present general inventive concept has been illustrated by description of several embodiments, it is not the intention of the applicant to restrict or in any way limit the scope of the inventive concept to such descriptions and illustrations. Instead, the descriptions, drawings, and claims herein are to be regarded as illustrative in nature, and not as restrictive, and additional embodiments will readily appear to those skilled in the art upon reading the above description and drawings.

### PROPOSITIONS

1. A container (1), preferably a tank, in particular for liquids, wherein the container comprises at least one fiber-reinforced plastic component, in particular made of carbon fibers (CFK), fiberglass (GFK), aramide fibers (AFK), boron fibers (BFK), or hybrid materials, characterized in that
   the plastic component has a fiber-volume ratio of >40%, in particular in the range 45-80%, preferably in the range 50%-70%, and/or a porosity of <10%, in particular <5%, very preferably <1%, particularly preferred in the range 1%-0.1%.
2. A container according to Proposition 1,
   characterized in that
   the container (1) is designed as having at least two parts, wherein the first container part is an upper shell (7) and the second container part is a lower shell (3).
3. A container according to one of the Propositions 1 to 2,
   characterized in that
   the container includes reinforcement walls.
4. A method for producing a container, preferably a tank, in particular for fluids, preferably according to one of the Propositions 1 to 3, wherein the container is made from a dry-fiber composite semi-finished material by means of an injection method for injecting matrix material,
comprising the following steps:
   Arranging fabric layers or continuous-strand mats (11, 111) made of carbon fibers (CFK), fiberglass (GFK), aramide fibers (AFK), boron fibers (BFK) or hybrid materials in the form of at least one part of the container in a mold (9) producing a dry fiber-composite semi-finished material
   Formation of a first space (20) by means of a membrane (13) that is permeable to gas and impermeable to a matrix material, wherein the first space (20) surrounds the dry fiber-composite semi-finished material
   Formation of a gap between the first space and the second space located in the environment second space (30) by means of a foil (15) that is permeable to gas and matrix material.
   Injection of matrix material into the first space (20) and the extraction of air from the second space (30), whereby the matrix material permeates the dry fiber-composite semi-finished material, producing at least one part of the container, preferably a tank.
5. A method according to Proposition 4,
   characterized in that
   the dry fabric layers or continuous-strand mats (11, 111) produce the form of a lower shell (3) of the container.
6. A method according to Proposition 5,
   characterized in that
   the dry fabric or continuous-strand mats (11, 111) in the form of a lower shell (3) include additional fabric layers or continuous-strand mats in the reinforcement region of the lower shell (3).
7. A method according to Proposition 5,
   characterized in that
   the container (1), in the region of the reinforcement walls, includes additional layers of material or continuous-strand mats (11, 111).
8. The use of a method according to one of the Propositions 4 to 7 for producing containers, preferably a tank, in particular for fluids.

What is claimed is:

1. A container, preferably a tank, in particular for liquids, comprising
at least one fiber-reinforced plastic component, wherein the fiber-reinforced component includes a combination mat, in particular a sandwich mat having a non-woven structure and reinforcement materials that are connected to the nonwoven structure, in particular the fiber materials.

2. The container of claim 1 wherein the nonwoven structure is a polypropylene (PP) structure.

3. The container of claim 1 wherein the fiber material is comprised of carbon fibers (CFK), aramide fibers (AFK) or boron fibers (BFK), or hybrid materials.

4. The container of claim 1 wherein the plastic component has a fiber-volume ratio greater than 40%, in particular in the range 40-80%, preferably in the range 40-50%.

5. The container of claim 1 wherein the plastic component has a porosity less than 10% and a surface that has a very high degree of smoothness.

6. The container of claim 1 wherein the container has a volume and the volume is greater than 10,000 L, preferably greater than 16,000 L, in particular greater than 20,000 L, and preferably in the range 10,000 L to 40,000 L, in particular 16,000 L to 30,000 L.

7. The container of claim 1 wherein the container is designed as having at least two parts, whereby the first container part is an upper shell, and the second container part is a lower shell.

8. The container of claim 7 wherein at least one shell has joining surfaces and on the joining surfaces an adhesive is applied, in particular a vinyl ester adhesive, in order to join the shell.

9. The container of claim 8 wherein, in order to insert the reinforcement walls, an adhesive, in particular a vinyl ester adhesive, is applied to the lateral walls of the container.

10. The container of claim 1 wherein the container includes reinforcement walls.

11. The container of claim 10 wherein at least one shell has joining surfaces and on the joining surfaces an adhesive is applied, in particular a vinyl ester adhesive, in order to join the shell.

12. The container of claim 11 wherein, in order to insert the reinforcement walls, an adhesive, in particular a vinyl ester adhesive, is applied to the reinforcement walls.

13. A method of producing a container, preferably a tank, in particular for liquids, wherein the container is produced from a dry fiber-composite semi-finished material by means of an injection method for injecting matrix material, comprising the following steps:
i. arranging of dry fabric layers in the form of combination mats in a mold producing a dry fiber-composite semi-finished material;
ii. forming a first space by means of a membrane that is permeable to gas and impermeable to matrix material, wherein the first space surrounds the dry fiber-composite semi-finished material;
iii. forming a gap between the first space and the second space lying in the surrounding area by means of a foil that is permeable to gas and matrix material; and
iv. injecting matrix material into the first space and the extraction of air from the second space, whereby the matrix material permeates the dry fiber-composite semi-finished material, produces at least one part of the container, in particular of the self-supporting container, preferably of the tank.

14. The method according to claim 13 wherein combination mats are comprised of carbon fibers (CFK), aramide fibers (AFK), boron fibers (BFK), or hybrid materials.

15. A method of producing a container, preferably a tank, in particular for liquids, whereby the container is made from a dry fiber-composite semi-finished material by means of an injection method for injecting matrix material, comprising the following steps:
arranging of dry fabric layers in the form of combination mats producing at least one part of the container in a female mold producing a dry fiber-composite semi-finished material;
arranging of a male mold in relation to a female mold in such manner that the fiber-composite semi-finished material comes to rest between the female mold and the male mold;
injecting matrix material into the space, supported by a pressure or height differential between the female mold and the male mold, in particular by means of a pump, in such a way that the matrix material permeates the dry fiber-composite semi-finished material, producing at least one part of the container, in particular the self-supporting container, preferably the tank.

16. The method of claim 15 wherein, before injection of the matrix material, the male mold and female mold are brought into contact with each other by means of a locking vacuum.

17. The method of claim 15 wherein, before and during injection of the matrix material, a container volume is formed.

18. The method of claim 15 wherein the injection of the matrix material is done under an injection pressure of 0.5 to 0.7 bar, preferably provided by a pump.

19. The method of claim 15 wherein the dry fabric layers produce the form of a lower shell of the container.

20. The method of claim 15 wherein the dry fabric layer in the form of a lower shell (3), in the reinforcement region of the lower shell, includes additional fabric layers of continuous-strand mats.

21. The method of claim 15 wherein the container, in the region of the reinforcement walls, has additional fabric layers.
